(19) United States
(12) Patent Application Publication
(10) Pub. No.: US 2017/0004528 A1
(43) Pub. Date: Jan. 5, 2017

(54) Affiliate-Driven Benefits Matching System and Methods

(71) Applicant: Bernard R. Baker, III, West Palm Beach, FL (US)

(72) Inventor: Bernard R. Baker, III, West Palm Beach, FL (US)

(73) Assignee: UMB International, LLC, West Palm Beach, FL (US)

(21) Appl. No.: 15/238,622

(22) Filed: Aug. 16, 2016

Related U.S. Application Data
(63) Continuation of application No. 14/687,634, filed on Apr. 15, 2015.
Application No. 14/687,634 is a continuation of application No. 13/089,881, filed on Apr. 19, 2011, now abandoned.
(60) Provisional application No. 61/437,097, filed on Jan. 28, 2011.

(51) Int. Cl. G06Q 30/02

(52) U.S. Cl. CPC G06Q 30/0255; G06Q 30/0261

(57) ABSTRACT

In a method of matching a consumer to available benefits, benefit information is received for at least one benefit that an affiliate knows is offered by an enabling organization. From a consumer, enabling organization information is received pertaining to an enabling organization with which the consumer is affiliated. Consumer information is received from the consumer, including consumer identification information for identifying the consumer and consumer interest data for identifying an interest of the consumer. The consumer information, enabling organization information, and benefit information are stored in a computer memory. The consumer interest data, enabling organization information, and benefit information are analyzed automatically to determine whether any enabling organization to which the consumer is affiliated is offering a benefit for the consumer that is applicable to the consumer interest data. A message is displayed to inform the consumer of an available benefit applicable to the consumer interest data.

### PRIORITY CLAIM AND CROSS-REFERENCE

The present application is a continuation of and claims priority benefit of U.S. application Ser. No. 14/687,634 entitled “Affiliate-Driven Benefits Matching System and Methods” filed 15 Apr. 2015, which itself claims priority benefit of Ser. No. 13/089,881 entitled “Affiliate-Driven Benefits Matching System and Methods” filed 19 Apr. 2011 which itself claims priority benefit of U.S. Provisional Application No. 61/437,097, filed on 28 Jan. 2011, the entirety of each is incorporated herein by reference. This application is related to U.S. application Ser. No. 13/089,840 entitled “Affiliate-Driven Benefits Matching System and Methods” filed 19 Apr. 2011 and U.S. application Ser. No. 13/089,918 entitled “Affiliate-Driven Benefits Matching System and Methods” filed 19 Apr. 2011, the entirety of each is hereby incorporated herein by reference.

### BACKGROUND

In the modern marketplace, various types of relationships link individuals, organizations, and/or goods/service providers to one another. Individuals may seek goods or services from a goods/service provider that provides goods and/or services. For example, an individual may be interested in attending an event such as a basketball game that is provided by a basketball league or association. Organizations are often aware of such interests and may form relationships with goods/service providers that enable the organizations to provide benefits to their constituencies that are related to such interests. For example, a credit card issuer may offer tickets to a basketball game at a reduced rate or for free to its cardholders, possibly contingent on some condition such as a minimum charge threshold. Offering such a benefit may have the effect of rewarding existing cardholders and thus strengthening a relationship between the cardholders and the credit card issuer. New cardholders may also be enticed to form an affiliation with the credit card issuer, e.g., by signing up for one of its credit cards, based on the desirability of the benefits offered by the card issuer.

Consumers face certain challenges in such a marketplace. Consumers may be eligible for various benefits offered by various organizations but may not be able to access such information in a convenient way. For example, an individual may not even know of all the benefits to which she is entitled, or she may not know all the various websites she must visit in order to access information regarding benefits from various organizations. Even if she knows all her available benefits, she may not know of any restrictions on claiming the benefits or whether the benefits are even valuable. For example, a cardholder who is entitled to free basketball tickets might not be aware that the tickets are only valid for a particular game, that the tickets correspond to an undesirable seat location, or that the tickets must be picked up through a convoluted process. Also, she may not have the information available at the time when she is making the decision to purchase. With these and other drawbacks, individuals may under-utilize their available benefits or be disappointed in them, making the entire process of offering benefits less productive or efficient to consumers, organizations, and goods/service providers alike.

### SUMMARY

The increased use of “social media” and other electronic means of communication among consumers will make it possible for consumers to pool information about benefits in one place, thereby reducing or eliminating the above drawbacks. As discussed herein, the present inventive embodiments overcome the above drawbacks to thereby increase the usefulness and efficiency of benefit programs.

An embodiment is a computer-implemented method for matching a consumer to available benefits. The method may include receiving, from a first affiliate (as a non-limiting example, a credit card holder) of an enabling organization (as a non-limiting example, a credit card issuer), benefit information pertaining to at least one benefit that the affiliate knows is offered by the enabling organization. The enabling organization may be one (or more) of multiple enabling organizations. From a consumer, enabling organization information may be received pertaining to an enabling organization with which the consumer is affiliated. Also, consumer information may be received from the consumer, including consumer identification information for identifying the consumer and consumer interest data for identifying at least one interest of the consumer (as a non-limiting example, an item the consumer wishes to purchase). In a memory of a computer system, the consumer information, enabling organization information, and benefit information may be stored. The consumer interest data, enabling organization information, and benefit information may be analyzed automatically in the computer system to determine whether any enabling organization to which the consumer is affiliated is offering a benefit for the consumer that is applicable to the consumer interest data. A message may be displayed to inform the consumer of an available benefit applicable to the consumer interest data.

An embodiment is a computer-implemented method for matching a consumer to available benefits. The method may include receiving, from a consumer, enabling organization information pertaining to an enabling organization (or multiple enabling organizations), among a plurality of enabling organizations, with which the consumer is affiliated and consumer information. The consumer information may include consumer identification information for identifying the consumer and consumer interest data for identifying at least one interest of the consumer. The method also includes providing benefit information pertaining to at least one benefit offered by one of the enabling organizations. In a memory of a computer system, the consumer information, enabling organization information, and benefit information may be stored. A rating and/or evaluation of one of the benefits offered by that one enabling organization may be received from an affiliate of that enabling organization different from the consumer. The consumer interest data, enabling organization information and benefit information may be analyzed automatically in the computer system to determine whether any enabling organization to which the consumer is affiliated is offering a benefit for said consumer that is applicable to the consumer interest data. A message may be displayed to inform the consumer of an available benefit applicable to the consumer interest data and may include the ratings and/or evaluations of the benefit provided by the other affiliates of the enabling organization.

An embodiment is a computer-implemented method for matching a consumer to available benefits. The method may include receiving, from a consumer, enabling organization information pertaining to an enabling organization (or multiple enabling organizations), among a plurality of enabling organizations, to which the consumer is affiliated and consumer information. The consumer information may include consumer identification information for identifying the consumer and consumer interest data for identifying at least one interest of the consumer. The method includes providing benefit information pertaining to at least one benefit offered by one of the enabling organizations. Benefit information may also be received from one or more enabling organizations. In a memory of a computer system, the consumer information, enabling organization information, and benefit information may be stored. The consumer interest data, enabling organization information, and benefit information may be analyzed automatically in the computer system to determine whether any enabling organization to which the consumer is affiliated is offering a benefit for the consumer that is applicable to the consumer interest data. In an event no benefit applicable to the consumer interest data is currently available, a message may be displayed to inform the consumer that he/she will be notified of a future benefit match. The consumer may be notified of a benefit applicable to the consumer interest data that subsequently becomes available.

An embodiment is a computer-implemented method for matching a consumer to available benefits. The method may include receiving, from an affiliate of one enabling organization, benefit information pertaining to at least one benefit that the affiliate knows is offered by the enabling organization. From a consumer, enabling organization information may be received pertaining to the enabling organization with which the consumer is affiliated. Also, consumer information may be received from the consumer, including consumer identification information for identifying the consumer and consumer interest data for identifying at least one interest of the consumer. In a memory of a computer system, the consumer information, enabling organization information, and benefit information may be stored. The consumer interest data, enabling organization information, and benefit information may be analyzed automatically in the computer system to determine whether the enabling organization is offering a benefit for the consumer that is applicable to the consumer interest data. A message may be displayed to inform the consumer of an available benefit applicable to the consumer interest data.

Some embodiments are benefits matching systems including one or more computer processors, a memory coupled to the processor(s), and a computer readable storage medium that has computer-executable instructions stored tangibly thereon. When executed, the instructions cause the processor(s) to perform the operations of the above-described computer-implemented methods for matching a consumer to available benefits.

### BRIEF DESCRIPTION OF THE DRAWINGS

The following will be apparent from elements of the figures, which are provided for illustrative purposes and are not necessarily to scale.

FIG. 1 is a block diagram in accordance with some embodiments.

FIG. 2 is a block diagram of a computer system in accordance with some embodiments.

FIG. 3 is a flow diagram in accordance with some embodiments.

FIG. 4 is a flow diagram in accordance with some embodiments.

FIG. 5 is a flow diagram in accordance with some embodiments.

FIG. 6 is a flow diagram in accordance with some embodiments.

FIG. 7 is a flow diagram in accordance with some embodiments.

### DETAILED DESCRIPTION

This description of the exemplary embodiments is intended to be read in connection with the accompanying drawings, which are to be considered part of the entire written description.

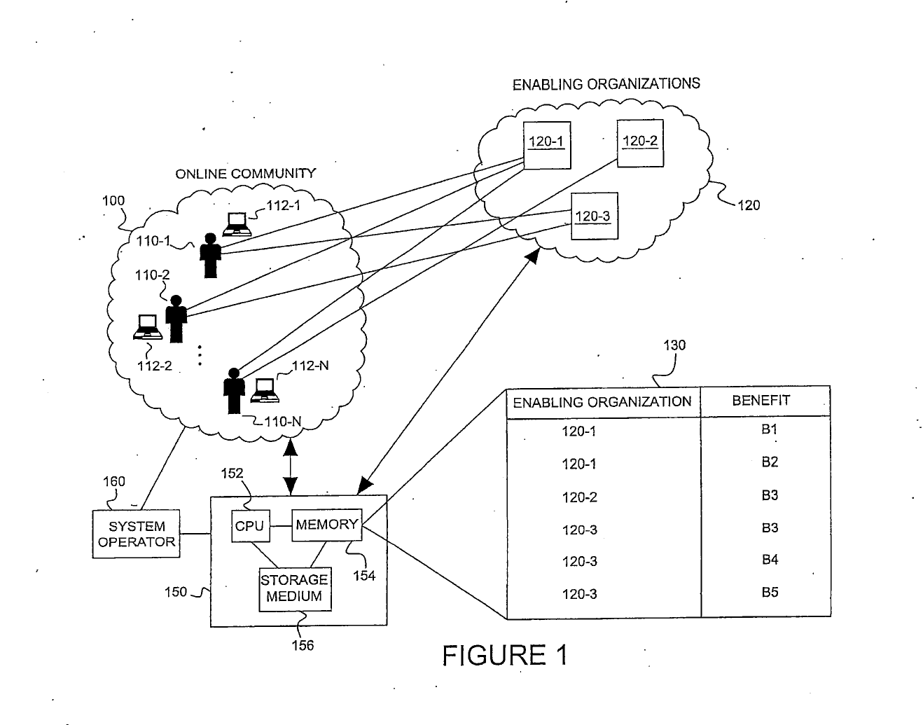

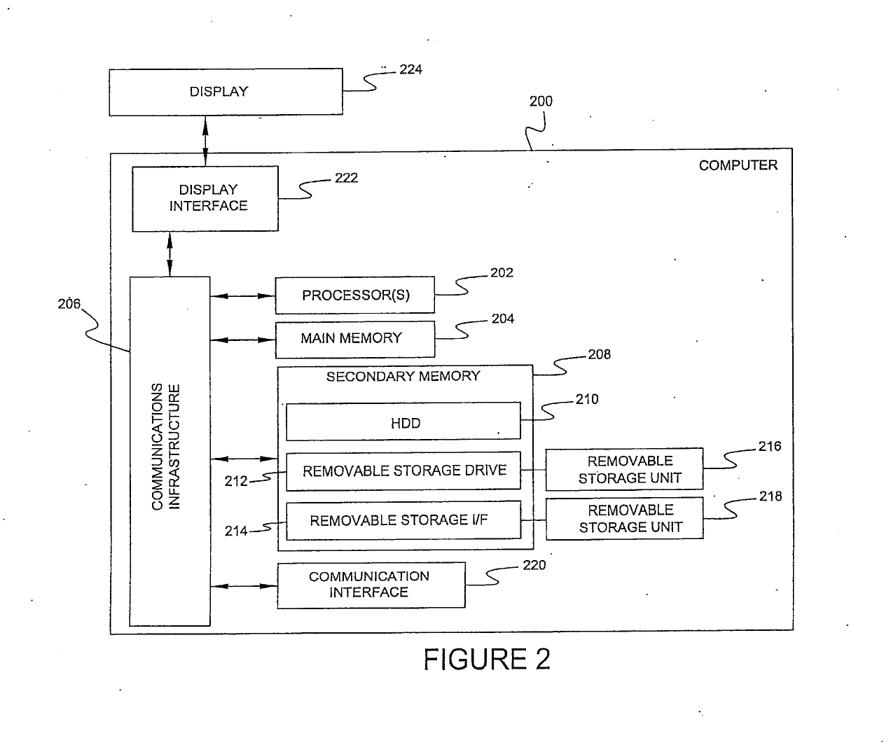

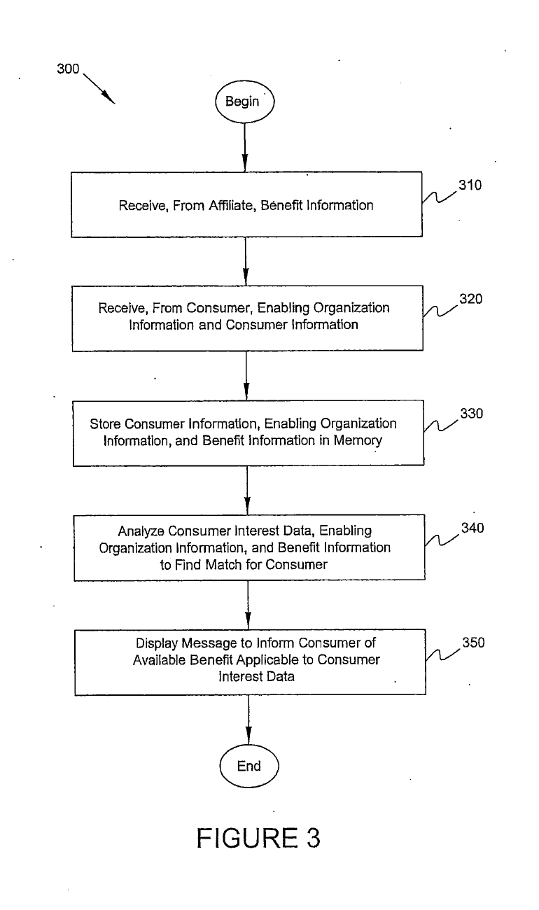

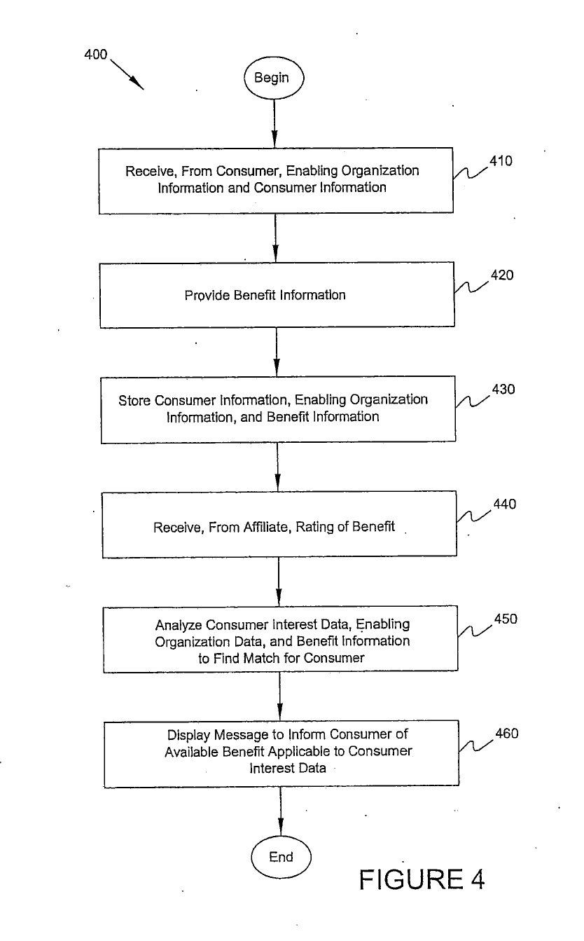

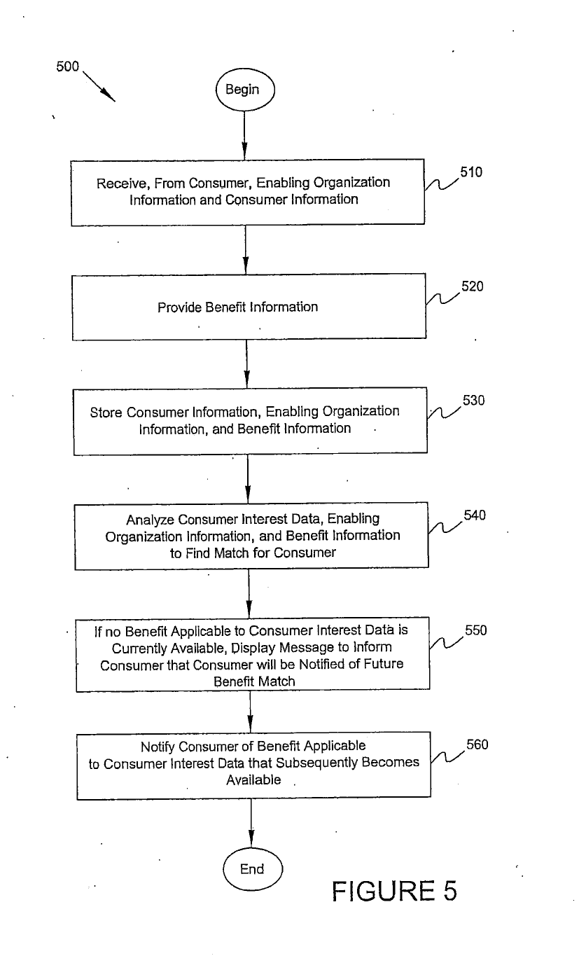

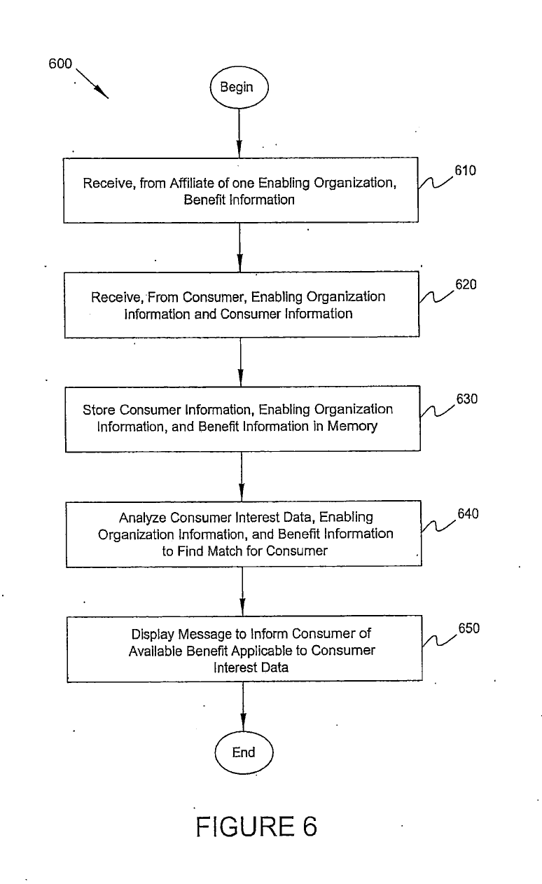

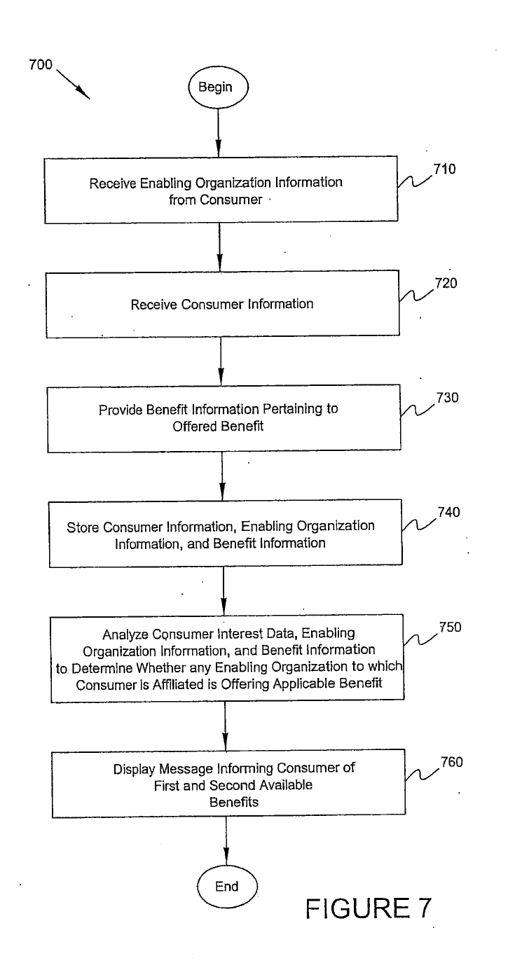

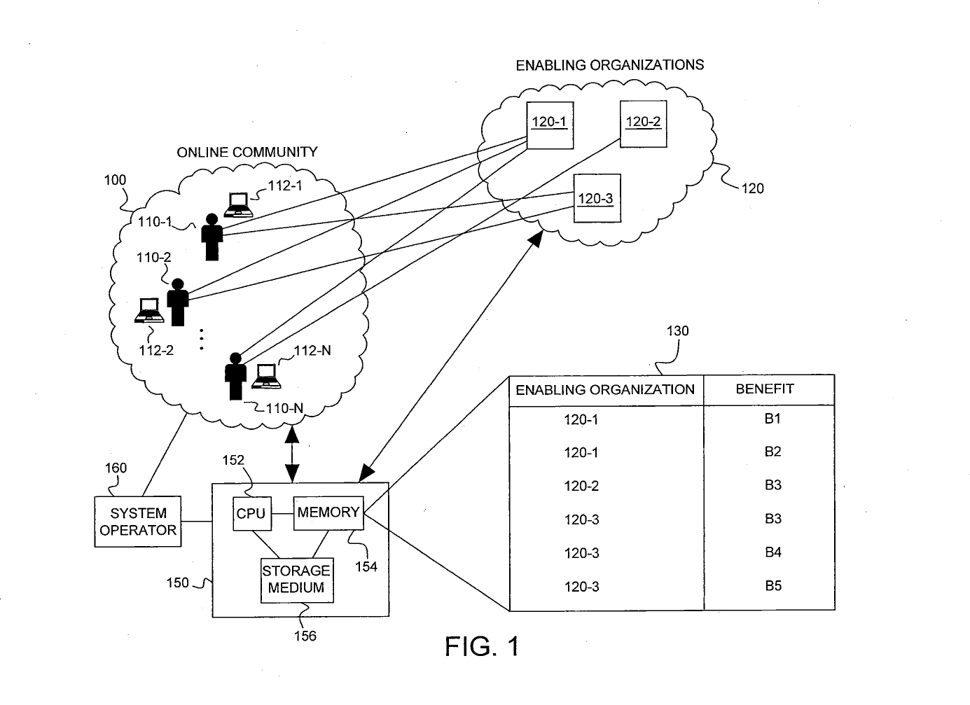

Referring to FIG. 1, an online community 100 includes users 110-1, . . . , 110-N (collectively 110) who are interested in utilizing benefits offered by benefit-enabling organizations (“enabling organizations” for short) 12Q. Users in online community 100 are also interested in providing information about such benefits to other users. Due to network effects, the more users 110 there are who provide information about benefits to other users, the better off the entire community 100 will be in terms of awareness and utilization of benefits.

In this example, enabling organizations 120-1, 120-2, and 120-3 are shown, although any number of enabling organizations, including a single enabling organization, may be present. User 110-1 is affiliated with (is an affiliate of) organizations 120-1 and 120-3, user 110-2 is affiliated with organizations 120-1 and 120-3, and user 110-N is affiliated with organizations 120-1 and 120-2. Alternatively, in another embodiment, the user may not be affiliated with any of the enabling organizations and may be gathering information which may be used in deciding to become affiliated with one or more enabling organizations. Each enabling organization provides (offers) one or more benefits to its affiliates.

Benefits

As used herein, the term “benefits” may refer to, for example, any discounted rate or any other added value (including but not limited to full value for a good or service) received by a consumer in addition to those otherwise offered to the general public. A benefit may be, for example, a discount or some other deal on a particular good or service (e.g., flowers from a particular florist, or any other product or service from a goods/service provider) that is available to a user because of her affiliation with an enabling organization (e.g., because she has a particular credit card). Benefits may include points, miles (e.g., airline miles), or upgrades (e.g., from coach to first class air tickets) that may be accrued for redemption in accordance with various commonplace rewards programs. Benefits may also include cash. Some embodiments particularly facilitate the use of benefits which are offered to those consumers having an affiliation with one or more enabling organizations, which may be third party enabling organizations that are distinct from the consumer and from the goods/services provider.

Affiliation/Affiliate

An “affiliation” as used herein may refer to, for example, an association or relationship that an entity (e.g., an individual, although not limited to individuals) has with an enabling organization that renders the entity capable of receiving a benefit from the enabling organization. An affiliate is an entity that has an affiliation with an enabling organization. Membership in the enabling organization may be such an association, although affiliation is broader than membership (e.g., an entity need not be a member to be an affiliate). Some embodiments allow consumers who are affiliates of third party enabling organizations to make advantageous use of such benefits offered through such enabling organizations by correlating the specific benefits offered with the needs of the consumer, e.g., when she desires to purchase a product.

Enabling Organization

Enabling organizations may be any type of organization that provides, as a service to its affiliates, benefits related to goods or services. Such goods or services themselves may be provided by another organization or by the enabling organization. Examples of enabling organizations may include credit card issuers, frequently flyer programs, automobile or motorists' associations, public television stations, organizations directed to a particular demographic (e.g., retired or elderly people), etc. Enabling organizations are sometimes referred to as affinity groups. Additionally, enabling organizations may be entities whose business or purpose is to offer benefits or coupons (e.g., groupon.com, eatoutpaylessonline.com, mypoints.com, etc.).

Individuals (or other entities such as companies) may be affiliates of numerous enabling organizations, which may sometimes create administrative challenges related to keeping track of available benefits. In some embodiments, using the power of online communities, a user may efficiently identify which of her enabling organizations, if any, provide a benefit related to a product she is interested in, based on inputs from other affiliate(s). For example, referring to FIG. 1, user 110-1 is affiliated with enabling organization 120-1, which offers benefits B1 and B2 to its affiliates. Enabling organizations may offer different sets of benefits to different affiliates, e.g., in a tiered affiliation/benefit paradigm. For the sake of illustration, assume that enabling organizations offer benefits to all of their respective affiliates as shown in table 130, which may be stored in a database, e.g., in a memory 154 of a computer system 150. In this example, enabling organization offers benefits 131 and 132, enabling organization 120-2 offers benefit B3, and enabling organization 120-3 offers benefits B3, B4, and B5. As shown in this example, a given enabling organization may offer multiple benefits, and a given benefit may be offered by multiple enabling organizations.

In some embodiments, users 110 may access and manipulate data pertaining to enabling organizations and/or benefits through a web-based interface. For example, users 110 may visit a predetermined web site on the Internet (e.g., a portal) to participate in online community 100. Various known forms of authentication may be used to verify that a user is entitled to access such information pertaining to the online community.

User 110-1 may be aware of benefit B1 offered by enabling organization 120-1, e.g., because she has previously used that benefit or because she has learned of it in some manner In some embodiments, user 110-1 may make this benefit information (e.g., the fact that a particular benefit is offered by a particular organization) known to the entire online community 100 by uploading the benefit information to system 150, e.g., using a computer terminal 112-1. Such uploaded benefit information is then available to other members of online community 100. System 150 may include a computer processor 152, a memory 154, and a computer readable storage medium 156. The uploaded benefit information may be stored in memory 154 at least until any applicable benefit expiration date(s). Computer terminal 112-1 may be a mobile device, e.g., a handheld computing platform such as a smart phone, or any suitable computing device. A handheld mobile device offers portability and convenience so that users may access functionality related to online community 100 from anywhere. For example, users may learn of benefits, upload information regarding benefits, or be matched to benefits from anywhere, and functionality related to geolocation and proximity detection as described below facilitates the utilization of benefits. As various users 110 populate the system 150 with information regarding various benefits, the entire community 100 enjoys greater awareness of such benefits through network effects.

By enabling affiliates of enabling organizations to directly provide benefit information to system 150, direct involvement with the enabling organizations 120 is not needed in some embodiments. Securing the cooperation and participation of enabling organizations is generally a resource-intensive problem that conventionally requires contacting and negotiating, and/or contracting with each of several enabling organizations. If any enabling organization “holds out,” benefit information related to that organization may be difficult to access in conventional systems. In contrast, harnessing the benefit information provided directly by affiliates as in various embodiments is simple, fast, cost-effective, and efficient in terms of removing a bottleneck from the information aggregation and utilization process.

In some embodiments, affiliates may rate and/or evaluate benefits, e.g., so that other affiliates may be in a better position to determine the viability or applicability of the benefits. For example, suppose user 110-1 has availed herself of benefit B1 (e.g., a discount on daffodils) offered by enabling organization 120-1 (e.g., a local florist). User 110-1 might have had a positive experience that she wishes to share with the online community 100 (e.g., the flowers were especially fresh and the service was prompt, or the discounted price was favorable and delivery was free, etc.). Alternatively, she might have had a negative experience (e.g., flowers were delivered late, or the discount only applied to certain flowers, etc.) or a neutral experience. She might have some information regarding her experience with the benefit that might be useful to others (e.g., the discount only applies to three-day-old flowers, or the discount only applies with the purchase of other flowers worth at least $50). In some embodiments, user 110-1 may provide a rating that captures such information. The rating may be qualitative (e.g., comments in the form of text), quantitative (e.g., a numerical score such as 3 out of 5 stars), or a combination of qualitative and quantitative feedback.

The rating for a particular benefit may be supplied by the same user who initially uploaded the benefit information pertaining to that benefit, or the rating may be supplied by a different user. For example, user 110-1 may upload benefit information for benefit B1 because she is aware of that benefit, but she might not supply a rating, e.g., because she has not used the benefit personally, because she has not formed an opinion of that benefit, because she does not wish to share her opinion, or for some other reason. User 110-2, who has also availed herself of benefit B1, may see that another user (in this case user 110-1) has provided information about benefit B1, and user 110-2 may supply a rating herself. In some embodiments, multiple users may supply a rating for the same benefit (e.g., users 110-1 and 110-2 both rate benefit B1), and the ratings from different users may be aggregated and/or combined (e.g., listed serially, averaged or combined via any other summary statistic).

In some embodiments, enabling organizations 120 may directly provide benefit information pertaining to the benefits that they offer, but only affiliates themselves (e.g., users 110) may rate the benefits. In this manner, users may have increased trust in the ratings and in the reliability of the benefits, as such information is provided directly by other users of the online community 100 rather than being provided by an enabling organization that has a vested interest in the matter. In some embodiments, information (e.g., benefit information or auxiliary information related to benefits) that is uploaded by an enabling organization is processed and/or displayed differently (e.g., with a different color or font, or in a different part of the screen) than information that is uploaded by an affiliate. By displaying benefit information received from affiliates and enabling organizations in different formats, users may perceive the source of such information, which may factor into their decision making processes.

In some embodiments, an affiliate of an enabling organization who provides a rating for a benefit may revise that rating. Additionally, some embodiments may include methods of detecting cheating on ratings and excluding or handicapping those ratings considered (or determined) to be falsified, suspicious, non-authentic, or lacking veracity. Handicapping may include giving less weight to certain ratings. One method of detecting cheating may include checking an identifying attribute (e.g., e-mail address or IP address) of an affiliate (or computer thereof) who provided multiple ratings in order to prevent “ballot box stuffing.” For example, reception of multiple ratings for a given benefit from the same email address (or the same IP address) may be a sign of cheating. Another method may include comparing the e-mail address or IP address of the affiliate who provided a rating regarding a benefit provided by a particular enabling organization with the e-mail address (e.g., domain) or IP address of that enabling organization to determine if there is a match. For example, a particular benefit may be offered by an enabling organization called XYZ. A rating that is received from an individual having email address joe@xyz.com may be regarded as suspect and a candidate for handicapping and/or exclusion, as that individual is likely an insider at the enabling organization. By “insider” is meant an employee or agent of an enabling organization, or some other person having a status with respect to the enabling organization that precludes that person from providing information regarding the enabling organization or its benefits in an unbiased, independent manner. Similarly, IP addresses may be compared to detect that a rating of a benefit offered by an enabling organization was provided from a computer located within that enabling organization's computer network. Thus, embodiments may detect the situation in which an individual poses as an affiliate of an enabling organization (who would presumably provide an independent and unbiased rating) but is actually the enabling organization's system administrator (for example) who has established a “front” for the enabling organization within the online community.

In some embodiments, various parties may provide information that facilitates the use of benefits. For example, in addition to uploading to system 150 the fact that enabling organization 120-1 offers benefit B1, user 110-1 may upload auxiliary information that is different from the mere existence of the benefit and that helps others use the benefit. Such auxiliary information may include a link (e.g., web hyperlink) to a web site of a service provider where the benefit may be obtained or redeemed, contact information relevant to acquiring or using the benefit, an expiration date of the benefit, or any other information that may be helpful to other users regarding the benefit. Such auxiliary information may be provided by a different user (e.g., user 110-2 in the example above) than the user who provided the basic benefit information, or it may be provided by an enabling organization or a system operator. In some embodiments, auxiliary information may be provided by affiliates but not by enabling organizations, in order to promote trust in such information on the part of users. A system operator 160 may be an individual who moderates or oversees the online community 100 and fills in helpful information. The system operator 160 may also provide benefits information to the system. In some embodiments, a system operator 160 may be an automated agent (e.g., a “bot”) that detects benefit information provided by users 110 and automatically processes and supplies auxiliary information, e.g., through automated searches or database lookups.

User 110-N, who is an affiliate of enabling organization 120-1 and thus qualifies for benefit B1, may see (e.g., via her computer terminal 112-N that interfaces with system 150) that enabling organization 120-1 offers benefit B1, because that information has been previously supplied. User 110-N may also see auxiliary information and/or ratings related to benefit B1. User 110-N may also see information pertaining to other benefits (e.g., benefit B2) offered by enabling organization 120-1 as well as benefits offered by enabling organization 120-2.

In addition to accessing such “static” content related to various benefits and enabling organizations, user 110-N (or any other user) may also receive “dynamic” content tailored to her individual interests and/or needs in some embodiments. For example, user 110-N, who may be termed a consumer in this context, may be automatically matched by computer system 150 to pertinent information spanning various benefit organizations and/or service providers, sparing her the trouble of having to check each enabling organization of which she is an affiliate in turn for possible benefits. User 110-N may provide enabling organization information pertaining to one or more enabling organizations to which she is affiliated (e.g., enabling organizations 120-1 and 120-2 in the example of FIG. 1). User 110-N may also provide consumer information, including consumer identification information for identifying her (e.g., a user ID, name, or other identifier) and consumer interest data for identifying at least one of her interests. Consumer interest data may include general topics such as hiking, more tailored interests such as attending the opera in New York City on Saturday evenings, and/or specific information related to intended or desired purchases, such as an imminent purchase like a pair of shoes or a desire for travel in the more distant future using an airline ticket from Boston to Las Vegas during the first week of November.

The consumer information, enabling organization information, and benefit information may be stored in memory 154. The benefit information may have been provided by a different user than the user corresponding to the consumer information and enabling organization information. The consumer interest data, enabling organization information, and benefit information may be analyzed automatically in computer system 150 to determine whether any enabling organization to which user 110-N is affiliated is offering a benefit for her that is applicable to her consumer interest data. Automatic matches of such data may be effectuated by various computing techniques, as is known in the art of databases and search algorithms. For example, stored benefit information may be coded or represented in ways that enable searching at various levels of granularity. Thus, a given benefit such as “25% off any order of daffodils this Sunday” may be represented in system 150 in various categories that facilitate ease of querying, such as “daffodils,” “flowers,” “this Sunday,” “this weekend,” “discount,” etc. A user may search at any desired level of granularity (e.g., using various search terms in the example above) as she desires. Thus, the system 150 may hide from the user the underlying complexity of the particular database/query implementation used.

A message may be displayed to inform user 110-N of an available benefit (or benefits) applicable to her consumer interest data. The message may be in various forms, including but not limited to an icon, a pop-up window, displayed text, or any other visually perceptible format. The term “available” does not require benefit(s) to be active at the present time but also encompasses benefits that will become active in the future. The message informing the user of available benefit(s) may be displayed on computer terminal 112-N associated with user 110-N. The available benefit information may be provided and/or displayed to the user based on temporal and/or spatial factors. For example, the user may be informed of benefits that are available within a particular distance from her or from any specified location, or closest to her current location or any specified location. A list of nearest benefit matches may be sorted and presented to the user for increased convenience. The user may be apprised of available benefits based on timing considerations. For example, she may be informed of benefits that are currently active, that will be active soon (e.g., a deal that will be available the upcoming weekend) or that are only valid for a predetermined time period. Available benefits may be sorted based on timing, so that benefits that are active currently are displayed before benefits that will become active in the future, for example.

If multiple available benefits are applicable to the user's consumer interest data, some embodiments may display the available benefits in an order corresponding to a ranking of the benefits. The benefits may be ranked according to ratings, e.g., by displaying an available benefit having a higher rating before an available benefit having a lower rating. In some embodiments, a benefit having any rating may be ranked higher than (and be displayed before) a benefit having no rating. Benefits may also be ranked and displayed according to a predetermined quantitative metric related to the benefits. For example, if a user is entitled to a particular benefit (e.g., 10% discount on a particular desired product) based on her affiliation with a first enabling organization and a numerically (or in another way determinable) superior benefit (e.g., 20% discount on the product) based on her affiliation with a second enabling organization, the better benefit may be displayed first. In some embodiments, the predetermined metric may pertain to an absolute amount (e.g., cash back amount such as $10 off a good or service) rather than a relative (percentage) amount discounted.

In some embodiments, the user may be notified of a first benefit that is available through a first enabling organization to which she is affiliated, and she may also be notified of a second benefit that would be available to her if she were to become affiliated to a second enabling organization to which she is not currently affiliated. A message may be displayed to inform the user about the second enabling organization or about any benefit offered by that enabling organization. For example, user 110-1 who is first notified of a benefit (e.g., 10% discount) on tennis rackets available through enabling organization 120-1 to which she is affiliated may also be notified of a benefit (e.g., buy one, get one free) on tennis balls (or other tennis-related equipment) that would be available to her if she were to become affiliated with enabling organization 120-2. In some embodiments, in order to avoid flooding the user with information she may not want, information about enabling organizations to which the use is not currently affiliated, or information pertaining to benefits offered by such enabling organizations, is restricted or filtered based on proximity or similarity to the originally sought benefit. For example, a query for benefits related to tennis rackets may allow the user to learn of benefits on tennis rackets offered by enabling organizations to which she is currently affiliated as well as those to which she is not affiliated. Tennis rackets and tennis balls may be classified (automatically or manually) in a single category by the system, so that queries that result in notifications of benefits offered by enabling organization 120-1 regarding tennis rackets also may result in notifications of benefits offered by enabling organization 120-2 regarding tennis balls.

In some embodiments, a message may be displayed to invite the user to become affiliated with the other enabling organization to which she is not currently affiliated (enabling organization 120-2 in the example above). The user may provide an input indicating her desire to become affiliated, and the system may affiliate the user with that enabling organization. In some embodiments, if the user indicates a desire to become affiliated with an enabling organization, the system sends a message to that enabling organization indicating the user's desire. In other words, the system may act as a referral intermediary, in return for which referral the enabling organization may provide compensation. Thus, the system may directly form a new affiliation between the user and the new enabling organization or may serve as an intermediary in the affiliation process. In some embodiments, the system refers the user (e.g., directs the a web browser on the user's computer) to the new enabling organization's website.

Thus, a user (who may be regarded as a consumer in the context of desiring to purchase or use a good or service, or avail herself of a benefit related to a good or service) desiring to use her benefits (but not necessarily knowing the precise nature of her benefits, or which enabling organizations provide particular benefits) may input her consumer interest data (e.g., purchase plans, item she wishes to purchase, service she wishes to use, etc.). The system determines whether any enabling organization with which the user is affiliated provides benefits related to her consumer interest data and informs her of such benefit(s). Consumer interest data may encompass plans to purchase a good or service imminently or at any point in the future.

The user may decide whether to use such identified benefit(s) and may use the system for that purpose, e.g., by clicking on a link or contacting an enabling organization that is displayed. The system may receive an input from the user indicative of her desire to avail herself of such available benefit. For example, the user may click a button (or otherwise indicate to the system) that she wishes to book a ticket using mileage benefits, purchase flowers at a discount, etc. The system may purchase the good or service associated with said consumer interest data, or otherwise use the identified available benefit(s) (e.g., by notifying an airline or travel provider that a flight is to be booked using rewards miles) to execute the available benefit(s) for the user. Alternatively, the system may reserve such a transaction for a future time.

Such a purchase, reservation of a transaction, or execution of a benefit may also be performed in the context of a benefit that would be available if the user were to become affiliated with a new enabling organization (to which she is not currently affiliated). For example, the system may form or initiate the affiliation between the user and a new enabling organization and execute a benefit offered by that new enabling organization, saving the user time and effort.

Thus, in some embodiments, the user may directly access or use such identified benefits without having to take the intermediate step of contacting or visiting the website of an enabling organization providing such benefits. Eliminating this intermediate step may facilitate the user's use of benefits and make it more likely that benefits will actually get used.

If no benefits currently fit the user's purchase plans, the system may store the purchase plan information and notify the user if and when such a benefit becomes available (i.e., “push” the benefits information to the user, e.g., via email or text message). In order to avoid information overload, the user may request that only certain types of benefit information (e.g., benefits pertaining to museums, theater, dining, etc., in New York City) be pushed.

The system 150 may be accessed by mobile devices (e.g., smart phones) or any other type of computer (e.g., desktop or notebook computers). Functionality related to mobile devices may include geolocation facilities (e.g., GPS functionality to determine the user's location and display nearby goods/service providers). For example, a user may simply enter that she wishes to purchase flowers within the next twenty-four hours, and the system 150 may determine whether any applicable benefits (e.g., discounts on flowers offered by an enabling organization to which the user is affiliated) are available within that time period. The user may then view such available benefits (e.g., benefits available in her vicinity or in some specified area) as well as any available ratings or auxiliary information related to the benefits, and she may then conveniently purchase flowers without the conventional difficulties associated with handling such benefits in the marketplace.

In some embodiments, a user (e.g., user 110-1) may download an application to her computer (e.g., computer 112-1). The application enables the user to perform search queries on a search engine and receive benefit-related information in addition to conventional query results (search hits). In such an embodiment, the user may first complete registration information with the application to identify one or more enabling organizations to which she is affiliated. Authentication using any suitable technique may be performed at this stage to verify that the user does indeed have such affiliations. When the user accesses a compatible search engine (e.g., a search engine accessible via a public network such as the Internet or via a private network), information regarding benefits offered by enabling organizations is provided automatically to the user in accordance with various techniques described above, without requiring the user to separately perform a benefit-centric search. For example, with such a downloaded application running, the user may simply perform a search query (e.g., a search for “Statue of Liberty”) and receive, in addition to conventional search results from the search engine, benefit-related information enabled by system 150 (e.g., information on benefits such as discounted tours of the Statue of Liberty made possible by the user's affiliation with an enabling organization). Such benefit-related information may be presented using icons adjacent to conventionally displayed search results to indicate that a benefit is available, or in a sidebar display in a format similar to advertisements. Thus, various embodiments providing the user the option to use traditional search engines to obtain results regarding benefits or the option of visiting a portal focused on benefits as described above. In some embodiments, such a portal may include search engine functionality. The user may have the flexibility to choose the manner of searching for benefits that is most convenient to her.

In some embodiments, a user may view benefit information related to various enabling organizations that has been previously aggregated (supplied), and she may then decide whether to join any of the enabling organizations based on that information. For example, referring to the example of FIG. 1, a user 110-i (not shown) who desires benefit B4 may see the benefit information aggregated due to the inputs from other affiliates who uploaded benefit information, auxiliary information, or ratings related to benefit B4. Viewing such information may help user 110-i decide if enabling organization 120-3, which offers benefit B4, is worth joining. Alternatively, if multiple enabling organizations offer a particular desired benefit, viewing consolidated information related to such benefit for all such enabling organizations may assist her with decision making. In some embodiments, user 110-i may simply browse the aggregated information pertaining to various benefits and enabling organizations. Alternatively, user 110-i may input consumer interest data related to goods or services she desires, and the system 150 may automatically suggest applicable enabling organizations.

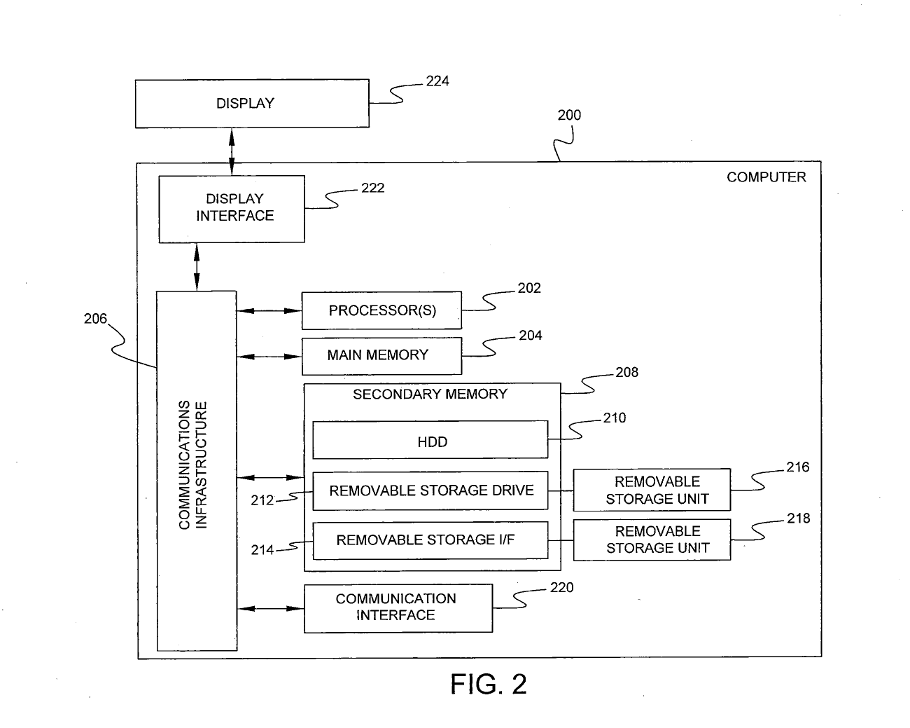

FIG. 2 illustrates one example of an architecture of a computer system 200 in accordance with some embodiments. Computer system 200 may be illustrative of computer system 150 of FIG. 1. As illustrated in FIG. 2, computer system 200 may include one or more processors 202. Each processor 202 is connected to a communication infrastructure 206 (e.g., a communications bus, cross-over bar, or network). Computer system 200 may include a display interface 222 that forwards graphics, text, and other data from the communication infrastructure 206 (or from a frame buffer not shown) for display on the display unit 224.

Computer system 200 may also include a main memory 204, such as a random access memory (RAM), and a secondary memory 208. The secondary memory 208 may include, for example, a hard disk drive (HDD) 210 and/or removable storage drive 212, which may represent a floppy disk drive, a magnetic tape drive, an optical disk drive, a memory stick, or the like as is known in the art. The removable storage drive 212 reads from and/or writes to a removable storage unit 216. Removable storage unit 216 may be a floppy disk, magnetic tape, optical disk, or the like. As will be understood, the removable storage unit 216 may include a computer readable storage medium having tangibly stored therein (embodied thereon) data and/or computer software instructions, e.g., for causing the processor(s) to perform the operations of the above-described computer-implemented methods for matching a consumer to available benefits.

In alternative embodiments, secondary memory 208 may include other similar devices for allowing computer programs or other instructions to be loaded into computer system 200. Secondary memory 208 may include a removable storage unit 218 (which may be similar to removable storage unit 216) and a corresponding interface 214, which may be similar to removable storage drive 212. Examples of such removable storage units include, but are not limited to, USB or flash drives, which allow software and data to be transferred from the removable storage unit 218 to computer system 200.

Computer system 200 may also include a communications interface 220. Communications interface 220 allows software and data to be transferred between computer system 200 and external devices such as a server. Examples of communications interface 220 may include a modem, Ethernet card, wireless network card, a Personal Computer Memory Card International Association (PCMCIA) slot and card, or the like. Software and data transferred via communications interface 22Q may be in the form of signals, which may be electronic, electromagnetic, optical, or the like that are capable of being received by communications interface 220. These signals may be provided to communications interface 220 via a communications path (e.g., channel), which may be implemented using wire, cable, fiber optics, a telephone line, a cellular link, a radio frequency (RF) link and other communication channels.

In this document, the terms “computer program medium” and “computer readable storage medium” refer to media such as media at removable storage drive 212, or a hard disk installed in hard disk drive 210, or removable storage unit 216. These computer program products provide software to computer system 200. Computer programs (also referred to as computer control logic) may be stored in main memory 204 and/or secondary memory 208. Computer programs may also be received via communications interface 220. Such computer programs, when executed by a processor, enable the computer system 200 to perform the features of the methods discussed herein. For example, main memory 204, secondary memory 208, or removable storage units 216 or 218 may be encoded with computer program code (instructions) for performing operations the above-described computer-implemented methods for matching a consumer to available benefits.

In an embodiment implemented using software, software instructions may be stored in a computer program product and loaded into computer system 200 using removable storage drive 212, hard drive 210, or communications interface 220, for example. In other words, the computer program product, which may be a computer readable storage medium, may have instructions tangibly embodied thereon. The software instructions, when executed by a processor 202, cause the processor 202 to perform the functions of (operations of) methods described herein, e.g., in processes 300, 400, 500, 600, and 700. In another embodiment, the method may be implemented primarily in hardware using, for example, hardware components such as a digital signal processor comprising application specific integrated circuits (ASICs). In yet another embodiment, the method is implemented using a combination of both hardware and software.

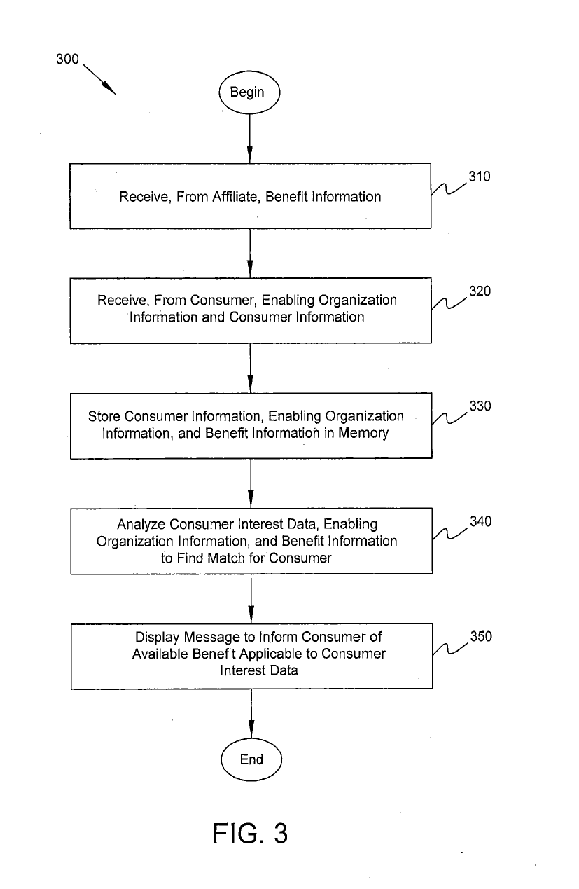

FIG. 3 is a flow diagram in accordance with some embodiments. After process 300 begins, the method may include receiving (310), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (320) pertaining to an enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (330). The consumer interest data, enabling organization information, and benefit information may be analyzed automatically (340) in the computer system to determine whether any enabling organization to which the consumer is affiliated is offering a benefit for the consumer that is applicable to the consumer interest data. A message may be displayed (350) to inform the consumer of an available benefit applicable to the consumer interest data.

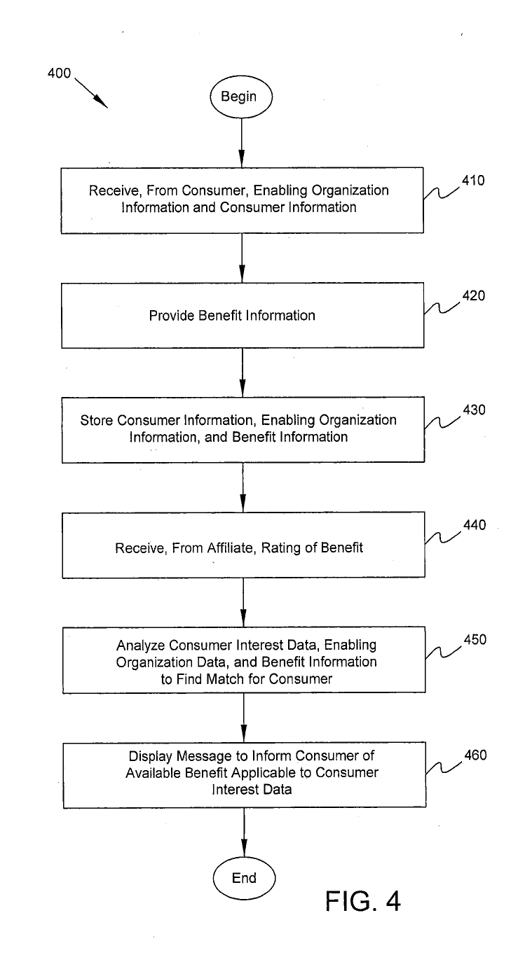

FIG. 4 is a flow diagram in accordance with some embodiments. After process 400 begins, the method may include receiving (410), from a consumer, enabling organization information pertaining to an enabling organization, among a plurality of enabling organizations, to which the consumer is affiliated and consumer information. The consumer information may include consumer identification information for identifying the consumer and consumer interest data for identifying at least one interest of the consumer. The method also includes providing benefit information (420) pertaining to a benefit offered by one of the enabling organizations. In a memory of a computer system, the consumer information, enabling organization information, and benefit information may be stored (430). A rating of one of the benefits offered by that one enabling organization may be received (440) from an affiliate of that enabling organization. The consumer interest data, enabling organization information and benefit information may be analyzed automatically (450) in the computer system to determine whether any enabling organization to which the consumer is affiliated is offering a benefit for said consumer that is applicable to the consumer interest data. A message may be displayed (460) to inform the consumer of an available benefit applicable to the consumer interest data and may include the ratings and/or evaluations of that benefit provided by other affiliates, consumers, or users.

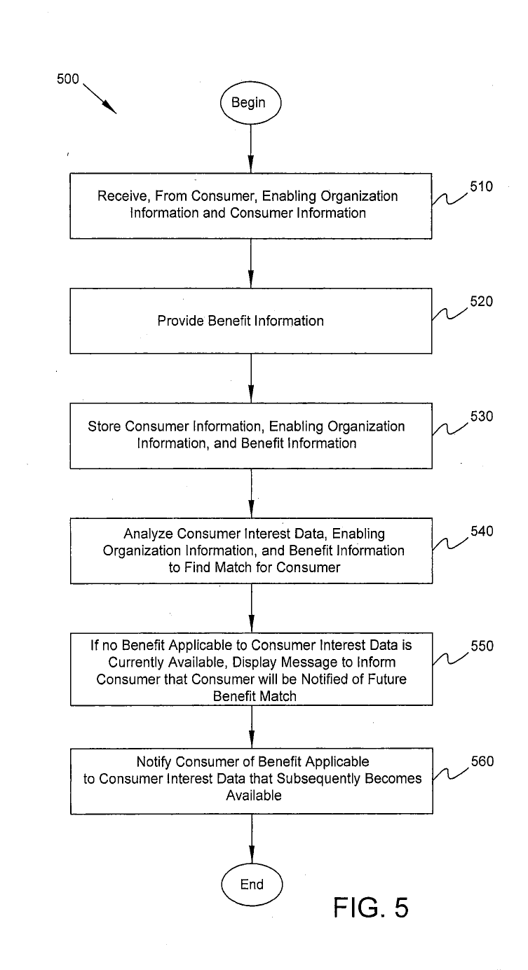

FIG. 5 is a flow diagram in accordance with some embodiments. After process 500 begins, the method may include receiving (510), from a consumer, enabling organization information pertaining to an enabling organization, among a plurality of enabling organizations, to which the consumer is affiliated and consumer information. The consumer information may include consumer identification information for identifying the consumer and consumer interest data for identifying at least one interest of the consumer. The method includes providing benefit information (520) pertaining to a benefit offered by one of the enabling organizations. In a memory of a computer system, the consumer information, enabling organization information, and benefit information may be stored (530). The consumer interest data, enabling organization information, and benefit information may be analyzed automatically (540) in the computer system to determine whether any enabling organization to which the consumer is affiliated is offering a benefit for the consumer that is applicable to the consumer interest data. In an event no benefit applicable to the consumer interest data is currently available, a message may be displayed (550) to inform the consumer that he/she will be notified of a future benefit match. The consumer may be notified of a benefit applicable to the consumer interest data that subsequently becomes available (560).

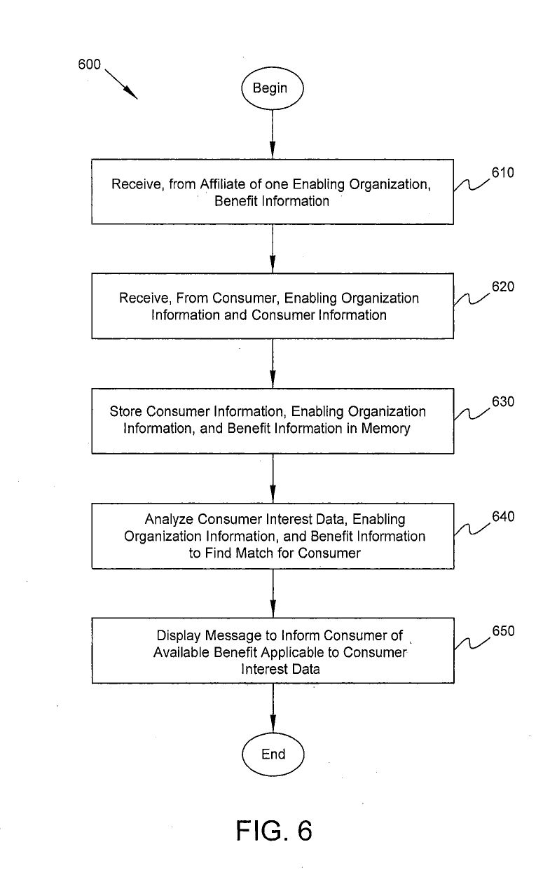

FIG. 6 is a flow diagram in accordance with some embodiments. After process 600 begins, the method may include receiving (610), from an affiliate of one enabling organization, benefit information pertaining to at least one benefit that the affiliate knows is offered by the enabling organization. From a consumer, enabling organization information may be received (620) pertaining to the enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (630). The consumer interest data, enabling organization information, and benefit information may be analyzed automatically (640) in the computer system to determine whether the enabling organization is offering a benefit for the consumer that is applicable to the consumer interest data. A message may be displayed (650) to inform the consumer of an available benefit applicable to the consumer interest data.

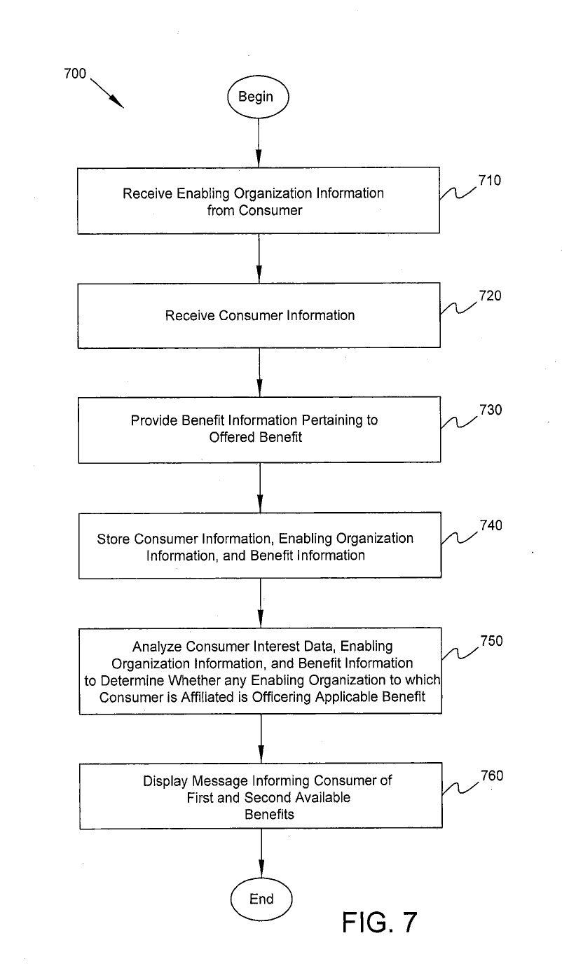

FIG. 7 is a flow diagram in accordance with some embodiments. After process 700 begins, the method may include receiving (710), from a consumer, enabling organization information pertaining to an enabling organization, among multiple enabling organizations, to which the consumer is affiliated. Consumer information may also be received (720), including consumer identification information for identifying the consumer and consumer interest data for identifying at least one interest of the consumer. The method may include providing (730) benefit information pertaining to at least one benefit offered by one of the enabling organizations. In a memory of a computer system, the consumer information, enabling organization information, and benefit information may be stored (740). The consumer interest data, enabling organization information and benefit information may be analyzed automatically (750) in the computer system to determine whether any enabling organization to which the consumer is affiliated is offering a benefit for the consumer that is applicable to the consumer interest data. A message may be displayed (760) to inform the consumer of a first available benefit and a second available benefit. The first available benefit may be applicable to the consumer interest data offered by a first enabling organization to which the consumer is affiliated. The second available benefit may be superior to the first available benefit according to a predetermined metric. The second available benefit may be applicable to the consumer interest data and may be offered by a second enabling organization to which the consumer is not affiliated.

Although examples are illustrated and described herein, embodiments are nevertheless not limited to the details shown, since various modifications and structural changes may be made therein by those of ordinary skill within the scope and range of equivalents of the claims.

What is claimed is:

1. A computer-implemented method for matching a consumer to available benefits, said method comprising:
receiving, from a consumer, enabling organization information and consumer information, said enabling organization information pertaining to a first, a second, and a third enabling organization, among a plurality of enabling organizations, with which said consumer has an affiliation, said affiliation being a pre-existing relationship with each of said first, second, and third enabling organization that enables said consumer to obtain at least one benefit from each of said first, second, and third enabling organization that are not otherwise available to said consumer, said consumer information including consumer identification information for identifying said consumer and consumer interest data for identifying at least one interest of said consumer;
storing in a memory of a computer system said consumer information, said first, second, and third enabling organization information, and first and second benefit information pertaining to a first and a second benefit, respectively, offered by said first and second enabling organizations, wherein said computer system is accessible to authenticated members of an online community;
receiving, from a first affiliate of said third enabling organization different from said consumer, a rating of a third benefit offered by said third enabling organization, wherein said first affiliate has an affiliation with said third enabling organization, said affiliation being a pre-existing relationship with said third enabling organization that enables said first affiliate to obtain said third benefit from said third enabling organization not otherwise available to said first affiliate;
authenticating, individually, said first affiliate and said consumer as each being a member of said online community who each are entitled to access information pertaining to benefits offered by at least one of the enabling organizations;
analyzing said consumer interest data, said enabling organization information and said third benefit information in said computer system to determine whether said third benefit is applicable to said consumer interest data; and
displaying a message to inform said consumer that said third benefit is applicable to said consumer interest data.

2. The method of claim 1, further comprising displaying to said consumer said rating of said third benefit.

3. The method of claim 1, wherein said first and second benefit information are provided by a respective second affiliate of each of said first and second enabling organizations, respectively, who knows that said first and second benefits are offered by said first and second enabling organizations, respectively, wherein said respective second affiliate has an affiliation with each of said first and second enabling organizations, respectively, said affiliation being a pre-existing relationship with each of said first and second enabling organizations, respectively, that enables said respective second affiliate to obtain at least one benefit from each of said first and second enabling organizations, respectively, not otherwise available to said respective second affiliate, and said respective second affiliate is an authenticated member of said online community.

4. The method of claim 1, wherein said message informs said consumer that said third benefit applicable to said consumer interest data is within a predetermined distance from a predetermined location.

5. The method of claim 4, wherein said predetermined location is a current location of said consumer.

6. The method of claim 1 wherein said message informs said consumer that said third benefit applicable to said consumer interest data is closer to a predetermined location than either said first or second benefit.

7. The method of claim 6, wherein said predetermined location is a current location of said consumer.

8. The method of claim 1 further comprising receiving, from said first affiliate, a revision to said rating.

9. The method of claim 1, further including receiving auxiliary information of said third benefit, said auxiliary information including an expiration date of said third benefit or a link to a website for description or redemption of said third benefit.

10. The method of claim 1, further comprising:
receiving an input from said consumer indicative of said user's desire to avail himself or herself of said third benefit; and
purchasing a good or service associated with said consumer interest data to execute said third benefit for said consumer.

11. A computer-implemented method for matching a consumer to available benefits, said method comprising:
receiving, from a consumer, enabling organization information and consumer information, said enabling organization information pertaining to a first, a second, and a third enabling organization, among a plurality of enabling organizations, with which said consumer has an affiliation, said affiliation being a pre-existing relationship with each of said first, second, and third enabling organization that enables said consumer to obtain at least one benefit from each of said first, second, and third enabling organization that are not otherwise available to said consumer, said consumer information including consumer identification information for identifying said consumer and consumer interest data for identifying at least one interest of said consumer;
storing in a memory of a computer system said consumer information, said first, second, and third enabling organization information, and first and second benefit information pertaining to a first and a second benefit, respectively, offered by said first and second enabling organizations, wherein said computer system is accessible to authenticated members of an online community;
receiving, from a first affiliate of said third enabling organization different from said consumer, a rating of a third benefit offered by said third enabling organization, wherein said first affiliate has an affiliation with said third enabling organization, said affiliation being a pre-existing relationship with said third enabling organization that enables said first affiliate to obtain said third benefit from said third enabling organization not otherwise available to said first affiliate;
authenticating, individually, said first affiliate and said consumer as each being a member of said online community who each are entitled to access information pertaining to benefits offered by at least one of the enabling organizations;
analyzing said consumer interest data, said enabling organization information and said third benefit information in said computer system to determine whether said third benefit is applicable to said consumer interest data; and
displaying, in an event that said third benefit applicable to said consumer interest data is not currently available, a message to inform said consumer that said consumer will be notified of a future benefit match; and
notifying said consumer when said third benefit applicable to said consumer interest data subsequently becomes available.

12. The method of claim 11 wherein notifying said consumer of said third benefit includes notifying said consumer of said third benefit applicable to said consumer interest data is within a predetermined distance from a predetermined location.

13. The method of claim 12, wherein said predetermined location is a current location of said consumer.

14. The method of claim 11 wherein said notifying said consumer of said third benefit includes notifying said consumer that said third benefit applicable to said consumer interest data is closer to a predetermined location than either said first or second benefit.

15. The method of claim 14, wherein said predetermined location is a current location of said consumer.

16. The method of claim 11 further comprising receiving, from said first affiliate, a revision to said rating.

17. The method of claim 11, further including receiving auxiliary information of said third benefit, said auxiliary information including an expiration date of said third benefit or a link to a website for description or redemption of said third benefit.

18. The method of claim 11, further comprising:
receiving an input from said consumer indicative of said user's desire to avail himself or herself of said third benefit; and
purchasing a good or service associated with said consumer interest data to execute said third benefit for said consumer.

19. A benefits matching system comprising:
a computer processor, wherein said computer processor is accessible to members of an online community who each are authenticated as being entitled to access information pertaining to benefits offered by at least one of a plurality of enabling organizations;
a memory coupled to said processor; and
a computer readable storage medium comprising computer-executable instructions stored tangibly thereon, said instructions when executed causing said processor to perform the operations of:
receiving, from a consumer, enabling organization information and consumer information, said enabling organization information pertaining to a first, a second, and a third enabling organization, among a plurality of enabling organizations, with which said consumer has an affiliation, said affiliation being a pre-existing relationship with each of said first, second, and third enabling organization that enables said consumer to obtain at least one benefit from each of said first, second, and third enabling organization that are not otherwise available to said consumer, said consumer information including consumer identification information for identifying said consumer and consumer interest data for identifying at least one interest of said consumer;
in said memory said consumer information, said first, second, and third enabling organization information, and first and second benefit information pertaining to a first and a second benefit, respectively, offered by said first and second enabling organizations, wherein said computer system is accessible to authenticated members of an online community;
receiving, from a first affiliate of said third enabling organization different from said consumer, a rating of a third benefit offered by said third enabling organization, wherein said first affiliate has an affiliation with said third enabling organization, said affiliation being a pre-existing relationship with said third enabling organization that enables said first affiliate to obtain said third benefit from said third enabling organization not otherwise available to said first affiliate;
authenticating, individually, said first affiliate and said consumer as each being a member of said online community who each are entitled to access information pertaining to benefits offered by at least one of the enabling organizations;
analyzing said consumer interest data, said enabling organization information and said third benefit information in said computer system to determine whether said third benefit is applicable to said consumer interest data; and
displaying a message to inform said consumer that said third benefit is applicable to said consumer interest data.

20. A benefits matching system comprising:
a computer processor, wherein said computer processor is accessible to members of an online community who each are authenticated as being entitled to access information pertaining to benefits offered by at least one of a plurality of enabling organizations;
a memory coupled to said processor; and
a computer readable storage medium comprising computer-executable instructions stored tangibly thereon, said instructions when executed causing said processor to perform the operations of:
receiving, from a consumer, enabling organization information and consumer information, said enabling organization information pertaining to a first, a second, and a third enabling organization, among a plurality of enabling organizations, with which said consumer has an affiliation, said affiliation being a pre-existing relationship with each of said first, second, and third enabling organization that enables said consumer to obtain at least one benefit from each of said first, second, and third enabling organization that are not otherwise available to said consumer, said consumer information including consumer identification information for identifying said consumer and consumer interest data for identifying at least one interest of said consumer;
in said memory said consumer information, said first, second, and third enabling organization information, and first and second benefit pertaining to a first and a second benefit, respectively, offered by said first and second enabling organizations information, wherein said computer system is accessible to authenticated members of an online community;
receiving, from a first affiliate of said third enabling organization different from said consumer, a rating of a third benefit offered by said third enabling organization, wherein said first affiliate has an affiliation with said third enabling organization, said affiliation being a pre-existing relationship with said third enabling organization that enables said first affiliate to obtain said third benefit from said third enabling organization not otherwise available to said first affiliate;
authenticating, individually, said first affiliate and said consumer as each being a member of said online community who each are entitled to access information pertaining to benefits offered by at least one of the enabling organizations;
analyzing said consumer interest data, said enabling organization information and said third benefit information in said computer system to determine whether said third benefit is applicable to said consumer interest data; and
displaying, in an event that said third benefit applicable to said consumer interest data is not currently available, a message to inform said consumer that said consumer will be notified of a future benefit match; and
notifying said consumer when said third benefit applicable to said consumer interest data subsequently becomes available.

21. The method of claim 3, wherein said rating is received from the second affiliate of said first enabling organization.

22. The method of claim 3, wherein said rating is received from the second affiliate of said second enabling organization.

23. The method of claim 3, wherein said third benefit offered by said third enabling organization is associated with at least one product or service offered by a goods/service provider distinct from said third enabling organization.

24. The method of claim 11, wherein said third benefit offered by said third enabling organization is associated with at least one product or service offered by a goods/service provider distinct from said third enabling organization.

25. The benefits matching system of claim 19, wherein said third benefit offered by said third enabling organization is associated with at least one product or service offered by a goods/service provider distinct from said third enabling organization.

26. The benefits matching system of claim 20, wherein said third benefit offered by said third enabling organization is associated with at least one product or service offered by a goods/service provider distinct from said third enabling organization.

27. The method of claim 1, further comprising:
determining that a fourth benefit, applicable to said consumer interest data and offered by one of said plurality of enabling organizations to which said consumer is not affiliated, is superior to said third benefit from the perspective of said consumer according to a predetermined metric, wherein said predetermined metric is a price discount percentage or a cash back amount,
wherein based on said determining, said message further informs said consumer of said fourth benefit.

28. The method of claim 27, further comprising displaying a second message to inform said consumer about said one of said plurality of enabling organizations to which said consumer is not affiliated or about any benefit offered by said one of said plurality of enabling organizations to which said consumer is not affiliated.

29. The method of claim 28, further comprising displaying a third message inviting said consumer to become affiliated with said one of said plurality of enabling organizations to which said consumer is not affiliated.

30. The method of claim 11, further comprising:
determining that a fourth benefit, applicable to said consumer interest data and offered by one of said plurality of enabling organizations to which said consumer is not affiliated, is superior to said third benefit from the perspective of said consumer according to a predetermined metric, wherein said predetermined metric is a price discount percentage or a cash back amount,
wherein based on said determining, said message further informs said consumer of said fourth benefit.

31. The method of claim 30, further comprising displaying a second message to inform said consumer about said one of said plurality of enabling organizations to which said consumer is not affiliated or about any benefit offered by said one of said plurality of enabling organizations to which said consumer is not affiliated.

32. The method of claim 31, further comprising displaying a third message inviting said consumer to become affiliated with said one of said plurality of enabling organizations to which said consumer is not affiliated.

33. The method of claim 1, further comprising detecting that said rating of said third benefit was received from a computer in a network associated with said third enabling organization.
